(19) United States
(12) Patent Application Publication
(10) Pub. No.: US 2026/0278805 A1
(43) Pub. Date: Sep. 17, 2026

(54) BOOTSTRAPPED ROTOSCOPE-MATTING TRAINING

(71) Applicant: Disney Enterprises, Inc.,, Burbank, CA (US)

(72) Inventor: Raphaël François ORTIZ, Dübendorf (CH)

(21) Appl. No.: 19/077,203

(22) Filed: Mar. 12, 2025

(51) Int. Cl. G06T 7/194; G06T 5/50; G06V 10/44; G06V 20/70

(52) U.S. Cl. CPC G06T 7/194; G06T 5/50; G06V 10/44; G06V 20/70; G06T 2207/20081; G06T 2207/20221

(57) ABSTRACT

Embodiments provide techniques for training machine learning models for rotoscoping and matting in VFX workflows. The method includes generating one or more foreground objects, comprising capturing real-world objects against one or more backgrounds using a color triangulation setup, or generating synthetic objects using multi-dimensional rendering models, generating one or more composite training samples by combining at least one of the one or more foreground objects with one or more simulated backgrounds, generating a first training dataset for a segmentation model, comprising annotating at least one of the one or more composite training samples to create a corresponding segmentation mask, and training the segmentation model to predict a segmentation mask for an input sample using the first training dataset.

### BACKGROUND

Rotoscoping and matting are integral processes in visual effects (VFX) workflows but remain repetitive and labor-intensive. Rotoscoping involves detecting and segmenting elements within a scene, typically using splines, control points, and tools like magnetic lassos or automated trackers to assist users. After rotoscoping generates a rough cutout, matting is performed to capture fine details and partial transparency, generating alpha mattes to define pixel-level transparency values and separating an image into layers accordingly. This separation allows for completing compositing tasks, such as background replacement or integrating foreground objects into new scenes. Recent developments in procedural techniques and machine learning-based methods have introduced partial automation into the VFX workflow, but challenges remain in handling complex edges and transparency, as well as maintaining temporal coherence in video applications.

### SUMMARY

One embodiment presented in this disclosure provides a method, including generating one or more foreground objects, comprising at least one of capturing real-world objects against one or more backgrounds using a color triangulation setup, or generating synthetic objects using multi-dimensional rendering models, generating one or more composite training samples by combining at least one of the one or more foreground objects with one or more simulated backgrounds, generating a first training dataset for a segmentation model, comprising annotating at least one of the one or more composite training samples to create a corresponding segmentation mask, and training the segmentation model to predict a segmentation mask for an input sample using the first training dataset.

Other embodiments in this disclosure provide computer-readable media containing computer program code that, when executed by one or more computer processors, performs operations in accordance with one or more of the above methods, as well as systems comprising one or more memories collectively containing one or more programs, and one or more processors, where the one or more processors are configured to, individually or collectively, perform operations in accordance with one or more of the above methods.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts four example images where real-world objects are captured using the color triangulation mechanism with different background, according to some embodiments of the present disclosure.

FIG. 2 is depicts four example images where synthetic objects are combined with checkerboard pattern backgrounds, according to some embodiments of the present disclosure.

FIG. 3 depicts example workflows for generating training samples, according to some embodiments of the present disclosure.

FIG. 4 depicts example workflows for training segmentation and matting models with prepared training samples, according to some embodiments of the present disclosure.

FIG. 5 depicts an example workflow for performing bootstrapped rotoscope-matting for real-time input using trained segmentation and matting models, according to some embodiments of the present disclosure.

FIG. 6 depicts the internal structures of a segmentation or matting model, according to some embodiments of the present disclosure.

FIG. 7 depicts an example method for preparing training data samples for segmentation and matting models, according to some embodiments of the present disclosure.

FIG. 8 depicts an example method for performing real-time inference using segmentation and matting models, according to some embodiments of the present disclosure.

FIG. 9 is a flow diagram depicting an example method for segmentation and matting model training, according to some embodiments of the present disclosure.

FIG. 10 depicts an example computing device configured to perform various aspects of the present disclosure, according to some embodiments of the present disclosure.

### DETAILED DESCRIPTION

Rotoscoping and matting remain repetitive and labor-intensive tasks in generating high-quality visual effects (VFX), virtual reality (VR), and augmented reality (AR) content. The term rotoscoping originally referred to an animation technique where artists would trace over live-action footage frame by frame to create animation. In the context of modern VFX, rotoscoping involves the detection and segmentation of elements within a scene, such as isolating characters or objects from their backgrounds.

Traditionally, rotoscoping is achieved by using splines and control points that are manually adjusted by users. This process often incorporates varying degrees of assistance from tools such as magnetic lassos, doodle-based segmentation, and automated trackers. While these tools can reduce the manual workload, the process still requires significant input to maintain accuracy, particularly in complex scenes with soft edges (e.g., hairs, fur) or semi-transparent objects (e.g., glass).

Rotoscoping typically provides a rough cutout of the desired foreground element. However, for compositing tasks like replacing a background or integrating elements into a new scene, a precise alpha channel is often desired for realistic blending (e.g., so the foreground colors can be unmixed from the original background to eliminate color contaminations and ensure smooth transition and realistic integration into a new background). The process of generating the alpha channel and separating the image into layers based on the alpha channel's data is referred to as matting. The alpha channel (also refereed as alpha matte) defines fine details, including soft edges and pixel-level transparency values. Based on this information, trimaps are created to separate the image into three regions: foreground, background, and an area of partial transparency. These trimaps are typically created manually or from segmentation masks generated by other methods. Despite advancements in tools and techniques, the processes of rotoscoping and matting in modern VFX workflows still require significant manual refinements and iterative corrections. This reliance on manual input makes the overall workflow less efficient and time-intensive. Additionally, conventional systems are unable to perform sufficiently accurate automatic rotoscoping and/or matting. Accordingly, techniques to streamline the VFX workflows and achieve higher precision in automatic or semi-automatic rotoscoping and matting tasks are desired.

The present disclosure provides methods, systems, and apparatuses that incorporate machine learning (ML)-based techniques into the rotoscoping and matting processes and enable automation or semi-automation with improved accuracy and efficiency. More specifically, the disclosed method involves training ML models to process input visual data (e.g., images, frames of video, or other visual media) and performing real-time segmentation and matting. This may include generating segmentation masks for distinguishing foreground and background elements, as well as producing high-quality alpha mattes that capture pixel-level transparency and fine details useful for compositing tasks.

In some embodiments, to further improve training efficiency and reduce the need for manual annotations, training datasets may be generated and refined using a variety of techniques. For example, real-world objects may be captured using a color triangulation method. This process recovers the true foreground colors and alpha values, mitigates issues such as color spill, and provides challenging edge cases in the training dataset. Once the object and relevant transparency information (e.g., segmentation masks, alpha channel) are identified, the foreground may be composited onto various backgrounds (e.g., solid, textured, or photorealistic) to generate training samples. In some embodiments, the system may procedurally generate synthetic objects (e.g., three-dimensional (3D) models of animals or plants) and combine them with simulated or procedurally generated backgrounds. Although these synthetic objects may not fully replicate the visual realism of real-world counterparts, these objects enable the creation of controlled and varied samples and expand the diversity of the training dataset. In some embodiments, multiple foreground objects (real-world or 3D-rendered objects) may be combined into a single background to simulate more complex and challenging scenes.

The training samples, once generated, are then processed to create segmentation masks, alpha channels, and other ground truth data used for training segmentation and matting models. The combined data is then provided into ML models, training the models to “undo” the compositional complexity-learning to separate layers, generate segmentation masks, and refine alpha channels. Once trained, the segmentation models and matting models may be deployed for real-time analysis. For example, the models may process real-time inputs to identify and extract foreground elements and background elements, as well as to refine transparency through alpha channels. Additionally, the output (e.g., identified foreground elements) may itself be used as part of a feedback loop to create new training data. For example, the foreground extracted by the models may be combined with new backgrounds to generate new training samples, which are then provided back into the training pipeline to iteratively retrain and improve the models.

The present disclosure discusses both the training and inference aspects of segmentation and matting models, including the preparation of training datasets, the setup of infrastructure within each model (e.g., designing and configuring encoders, transformers, and decoders), the detailed training process where the models learn to undo composite samples, and the real-time inference process where trained models process input images to extract foreground elements and refine transparency through alpha channels. With the disclosed approach, the overall VFX workflow may be automatic or semi-automatic through ML models, in some cases allowing for manual inputs to refine outputs where necessary. The hybrid capability improves the overall efficiency of VFX production while maintaining the flexibility to incorporate manual inputs for handling complex or challenging scenarios.

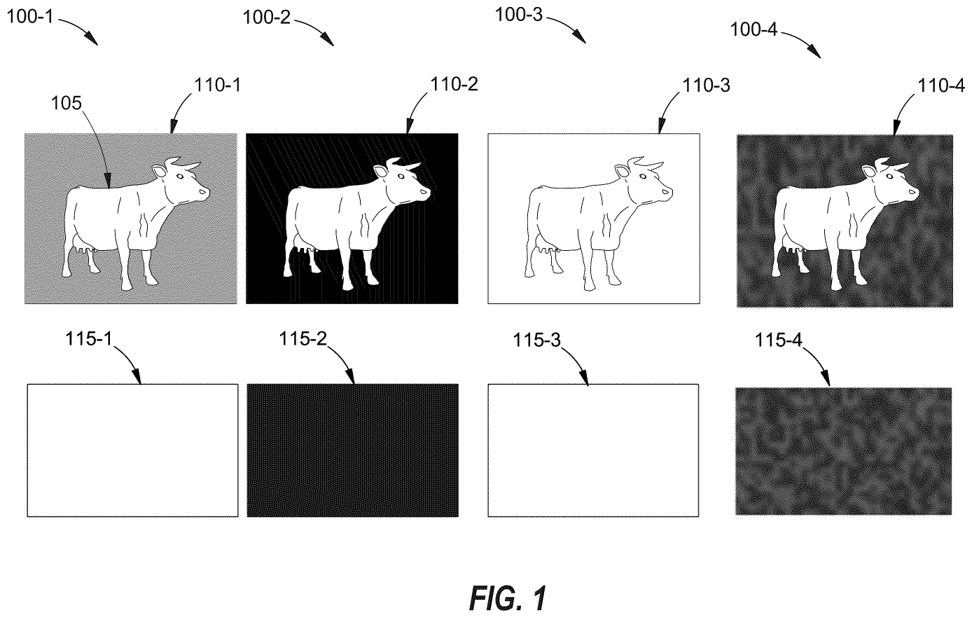

FIG. 1 depicts four example images 100 where real-world objects 105 are captured using the color triangulation mechanism with different backgrounds 110, according to some embodiments of the present disclosure.

Four example images 100 are provided in FIG. 1, each showing the same foreground object 105 captured against different backgrounds 110. More specifically, image 100-1 captures the object 105 against a checkerboard pattern background 110-1 (which is typically generated by a computer), image 100-2 captures the object 105 against a uniform black background 110-2, image 100-3 captures the object 105 against a uniform white background 110-3, and image 100-4 captures the object 105 against a smoothly varying randomly generated background 110-4.

As used herein, the smoothly varying randomly generated background 110-4 refers to a background where colors and/or brightness levels transition gradually and non-uniformly across the image. This background 110-4 is generated programmatically, using techniques like Perlin noise, Gaussian gradients, or similar procedural methods. The smoothly varying randomly generated background 110-4 is specifically designed to mitigate color spill, particularly in areas near the edges of the object or in semi-transparent regions.

As used herein, the object 105 refers to a real-world object, and the background 110 includes a wide range of types, including but not limited to, uniform color background (e.g., 110-2 and 110-3), procedurally generated background (e.g., 110-1) (backgrounds with patterns or textures generated by computers, such as mosaic patterns, noise patterns, and checkerboard patterns), smoothly varying background (e.g., 110-4), photorealistic backgrounds (e.g., captured real-world scenes), composite background (backgrounds generated by combining multiple layers or elements), and dynamic or animated background (backgrounds with motion or temporal changes). The process of generating such images 100 with varying backgrounds may involve placing the object 105 in front of a display (e.g., a large computer screen), while a camera is positioned to capture the object. The image displayed on the screen serves as the background, allowing synchronization between the displayed background and the camera capture process. This method may be primarily applicable to static objects. For dynamic objects or live objects, a high-frame rate setup, such as stagecraft technology, may be used to capture the live objects against varying backgrounds.

The color triangulation capture method involves a multi-step process to accurately extract the foreground object and its transparency information. First, the objects 105 is captured against multiple different backgrounds, each with a unique color, pattern, or lighting condition. Next, additional images 115 are captured, showing only the backgrounds without the object present. These background-only images 115 serve as reference points to account for any variations in lighting or environmental conditions.

Once the images are captured, a matting equation is applied to calculate the foreground and alpha channel. The matting equation uses the differences between the object-on-background images and the background-only images to isolate the foreground object and determine its transparency values. In some embodiments, the matting equation is defined using Equation 1 below.

$$C = ( F * a ) + ( B * ( 1 - a ) ) \qquad Equation 1$$

In Equation 1, F represents the foreground, such as true colors of the object 105, a (e.g., alpha) represents the transparency values at each pixel, C represents the composite data (e.g., the observed image of the object against the background), and B represents the background (e.g., the known pixel values of the background).

In some embodiments, to solve for the Foreground F and the Alpha a, the composite images 110 and the background images 115 are used. Furthermore, at least two groups of images may be used to form a linear system of equations with two unknowns (Foreground and Alpha) according to Equations 2 and 3 below:

$${C}_{1} = ( F * a ) + ( {B}_{1} * ( 1 - a ) )$$

$${C}_{2} = ( F * a ) + ( {B}_{2} * ( 1 - a ) )$$

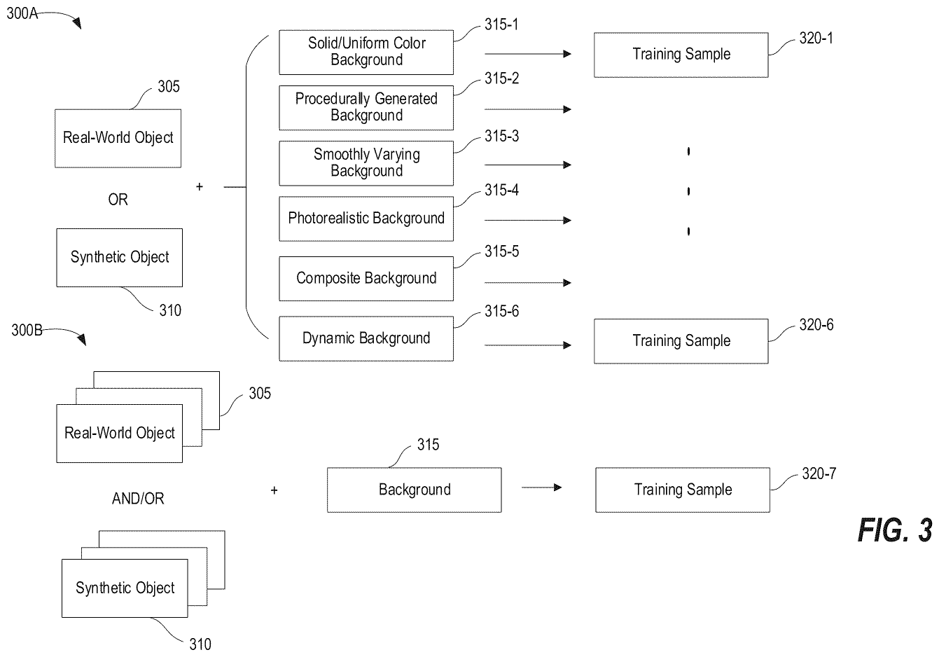

As depicted in FIG. 1, four composite images 110 are provided, each showing the object 105 against a different background (checkerboard pattern, black, white, and smoothly varying). These four composite images 100, along with the four background-only images 115, may be used to determine the foreground (e.g., object 105) and alpha values for each pixel by applying the matting equation 1. As discussed above, using different background colors can mitigate color spill (where background colors contaminate the edges of the object). Therefore, the accuracy of the determined foreground color and alpha values for object 105 is improved, particularly for changing areas such as soft edges (e.g., hair, fur) or semi-transparent regions (e.g., glass or transparent plastic). With the determined foreground color and transparency information, new training samples may be generated by compositing the extracted real-world object 105 onto diverse backgrounds. The edges and transitions may be adjusted based on the detailed transparency to facilitate high-quality compositing for training datasets. More details about compositing the extracted real-world objects to generate training samples are discussed below with reference to FIG. 3.

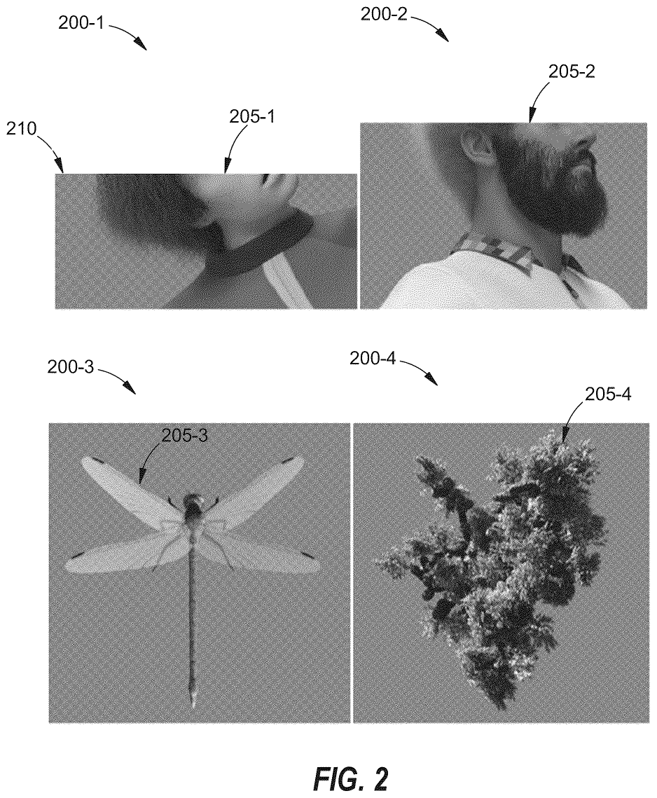

FIG. 2 is depicts four example images 200 where synthetic objects 205 are combined with checkerboard pattern backgrounds 210, according to some embodiments of the present disclosure.

Besides real-world objects (e.g., 105 of FIG. 1), synthetic objects 205 may also be used to generate training samples. The synthetic objects 205 typically refer to procedurally generated and rendered objects, including objects generated automatically or semi-automatically, as well as computer-generated images, rendered objects using specialized animation software and techniques, and computer-generated renders from live-action movies. Compared with real-world objects, synthetic objects are easier to scale up and provide perfect alpha ground truth. Since synthetic data is generated programmatically or created in controlled environments, the alpha values are exact and do not suffer from inaccuracies caused by color spill or imperfections during capture. For example, procedural hairs placed on human 3D models, as depicted by 205-1 and 205-2, may serve as an alternative to the challenging aspects of matting real people, such as handling intricate edges around hair. Additionally, animals and vegetation generated using a procedural content generation pipeline, as depicted by 205-3 and 205-4, may simulate intricate sharp boundaries, partially shadowed objects, and other challenging scenarios. Furthermore, synthetic rendering may also simulate objects and conditions that are difficult or impractical to replicate in real-life setups, such as translucent materials, unusual lighting conditions, or specific object textures.

In FIG. 2, four synthetic objects 205 are shown, each combined with a checkerboard pattern background 210. The checkerboard pattern background 210 is provided for conceptual clarity. In some embodiments, these synthetic objects 205 may be composited onto diverse backgrounds (e.g., mosaic patterns, noise patterns, uniform color, photorealistic, synthetic textured, and/or smoothly varying backgrounds) to generate a wide variety of training samples.

Compared with training samples generated from real-world objects—particularly those captured without using the color triangulation capture method—training samples generated with synthetic objects 205 do not suffer from color spill. This is because the alpha values and foreground colors for the synthetic objects 205 are generated programmatically, allowing them to be created directly without any background contamination. As a result, synthetic objects 205 may produce clean, precise training samples without the need for additional processing to correct for edge contamination or transparency inconsistencies. Additionally, synthetic data provides the advantage of simulating fast motion scenarios that are difficult or impossible to capture physically, such as rapidly moving objects or dynamic interactions. By combining training samples from both real-world objects and synthetic objects, a diverse training dataset is created. When applied to train ML models for segmentation and/or matting, this dataset enables the models to learn how to handle intricate details, such as soft edges and semi-transparent objects, and adapt to a wide range of real-world and synthetic scenarios, including those involving high-speed motion.

FIG. 3 depicts example workflows 300A and 300B for generating training samples, according to some embodiments of the present disclosure.

The workflow 300A, as depicted in FIG. 3, demonstrates the process of combining a single object—either a real-world object 305 or a synthetic object 310—with different backgrounds 315 to generate a variety of training samples 320. As discussed in FIG. 1, the color triangulation capture method is used to capture the real-world object 305 against multiple different backgrounds 315 (e.g., checkerboard pattern, black, white, smoothly varying backgrounds). Along with background-only images, the foreground color and alpha values for the object 305 may be determined, such as by using equation 1. Following the determination, the object is extracted without contamination (or with minimal or at least reduced contamination) from the background (e.g., color spill). As depicted, the extracted object 305 can then be composited onto multiple different types of backgrounds 315 to generate diverse training samples 320.

As depicted, the backgrounds 315 include a variety of types, including but not limited to, uniform color background 315-1 (which is a solid, single-color background that provides simple contrast for clear alpha extraction), procedurally generated background 315-2 (also referred to in some embodiments as synthetic background) (which is created programmatically and includes patents like mosaic patterns, noise patterns, or checkerboard patterns), smoothly varying background 315-3 (which is a background with gradual, non-uniform color transitions), photorealistic background 315-4 (which is a real-world image or scene that replicates natural environments with realistic lighting and textures), composite background 315-5 (which is a combination of multiple layers or elements, such as blending synthetic textures with photorealistic images), and dynamic background 315-6 (which is a time-varying background used to simulate real-world motion). The illustrated backgrounds 315 are provided for conceptual clarity and demonstrate examples of possible background types. In some embodiments, other types of backgrounds may be used, depending on specific application requirements. Further, in some implementations, fewer background types (e.g., a subset of the illustrated alternatives) may be used.

As discussed in FIG. 2, synthetic objects 310, such as computer-generated 3D models of humans, animals, or plants, are created programmatically or through controlled digital rendering processes. These objects inherently include ground truth data, such as their exact alpha values and foreground colors (which are free from color spill or capture errors). These synthetic objects 310, as depicted, can similarly be composited onto multiple backgrounds 315 to create diverse training samples 320. By compositing each object with multiple backgrounds, workflow 300A generates training samples 320 that enable ML models to learn how foreground objects interact with diverse background conditions. The ground truth data, including alpha values and foreground colors, may then be used as the target output for training segmentation and matting models.

The workflow 300B as depicted in FIG. 3 demonstrates the process of combining multiple objects—real-world objects, synthetic objects, or a mix of both—within a single background 315 to generate a training sample 320-7. The training sample 320-7 simulates complex environments where two or more foreground objects overlap, interact, or share boundaries with varying levels of transparency. As discussed above, the ground truth data for each object, including the foreground color and alpha channel, is preserved and can be used as the target output for training segmentation and matting models. In some embodiments, the generated training samples 320, along with the known ground truth data, may be further processed to generate trimaps with random dilation augmentation or masks of semi-transparent regions. The generated trimaps and semi-transparent masks may be used for training the matting models.

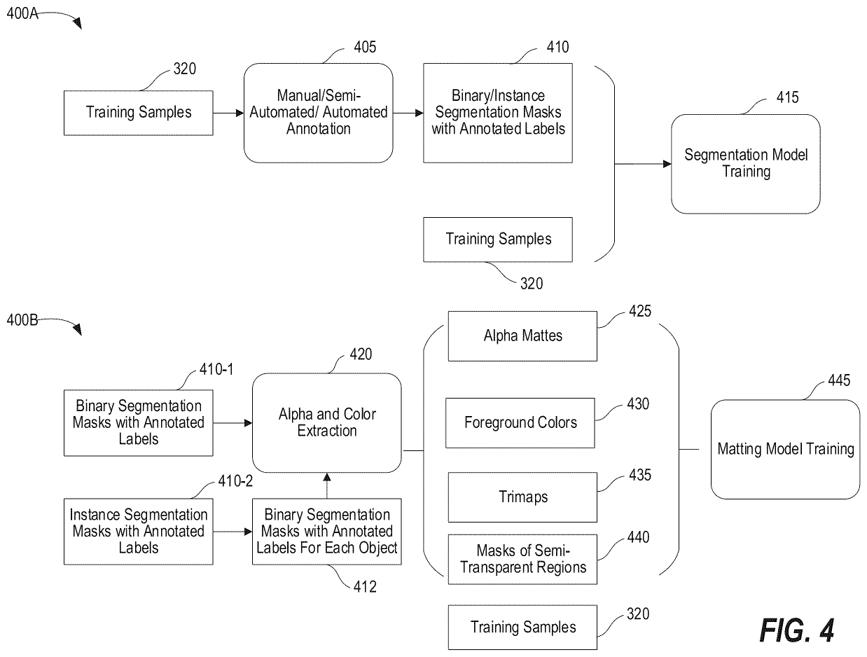

FIG. 4 depicts example workflows 400A and 400B for training segmentation and matting models with prepared training samples, according to some embodiments of the present disclosure.

The workflow 400A as depicted in FIG. 4 demonstrates the process of training the segmentation model. In this workflow, the segmentation model in this workflow is trained to take an image as input and generate binary segmentation masks with annotated labels: 0 for background and 1 for foreground. To prepare the training data, the training samples 320 may first be processed through an annotation module 405 to create the binary segmentation masks 410. These masks represent a simplified view of the image, where foreground objects (e.g., real-world objects 305 or synthetic objects 310 of FIG. 3) are labeled as 1 and background regions are labeled as 0. For example, if the training sample contains an image of a person against a background, the binary segmentation mask would mark all pixels corresponding to the person with 1 and the rest background pixels with 0. Binary segmentation masks simplify the initial segmentation process and allow the model to provide a clean foreground-background separation. These marks then be further refined by the matting model to handle details like soft edges and semi-transparent regions.

In embodiments where an image includes multiple objects, an instance segmentation mask may be generated where each object is assigned a unique label while keeping the background labeled as 0. For example, if an image contains three objects, the instance segmentation mask may label the pixels corresponding to object A as 1, the pixels corresponding to object B as 2, and the pixels corresponding to object C as 3. The background pixels are marked as 0. Although instance segmentation masks may contain multiple labels (e.g., Object A=1, Object B=2, Object C=3, and Background=0), the matting model processes each object individually in a binary manner during inference—treating the target object (e.g., Object A) as foreground (1) and everything else as background (0). Following that, the matting model generates an alpha matte and a foreground color image specifically for the selected object. The alpha matte defines the transparency levels for the selected object, and the foreground color image contains the true colors (e.g., RGB values) of the object without contamination from the background. This approach allows precise transparency handling and high-quality compositing when integrating each object into new scenes.

The annotation process for generating binary or instance segmentation masks 410 may be performed manually, semi-automated, or fully-automated. In some embodiments, manual annotation may be performed where experts manually draw splines and control points around objects in the image. This approach is labor-intensive but provides high accuracy. In some embodiments, models like Segment Anything Model (SAM) may be used to assist annotation. The SAM may generate segmentation masks from rough inputs, such as bounding boxes or points provided by the user. The semi-automated approach reduces the workload while still maintaining high precision. In some embodiments, particularly for synthetic objects (e.g., 205 of FIG. 2 or 310 of FIG. 3), render IDs contained within the synthetic data may be used directly to create segmentation masks, as the background and background regions are programmatically defined. This approach provides annotation without manual intervention.

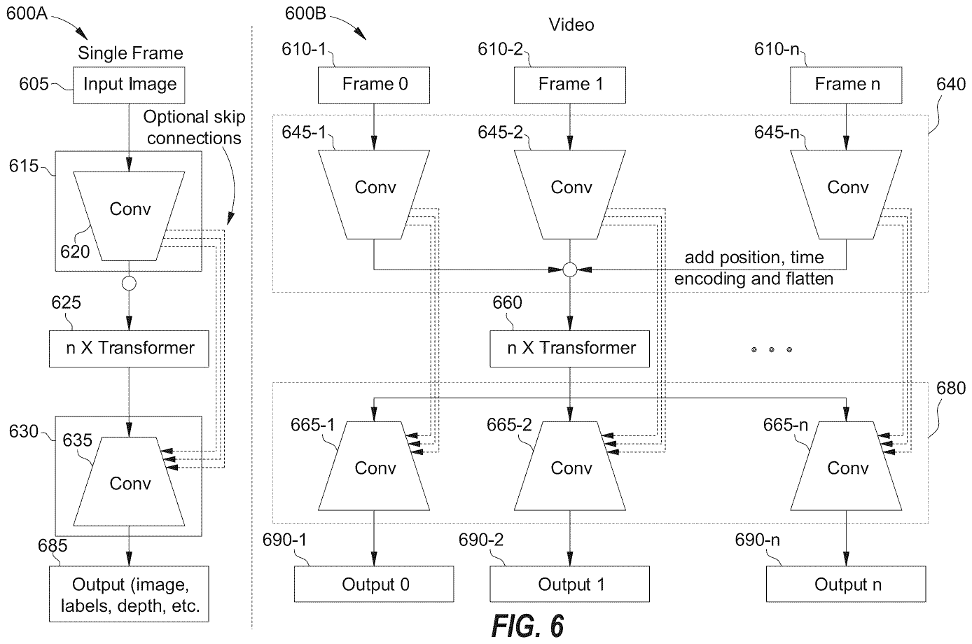

Once the binary/instance segmentation masks 410 are generated, they are paired with the original training images 320 and provided into the segmentation model for training 415. The model is trained to detect foreground objects, differentiate them from the background, and generate segmentation masks as output. In some embodiments, the segmentation model may use an UFormer architecture, which is a UNet with transformer blocks embedded in the middle to improve feature learning. The model includes three main components: the encoder, the transformer blocks, and the decoder. More details about the model's architecture are provided below with reference to FIG. 6.

As depicted, the original training images 320 serve as input to the model. Input features may be extracted by the encoder of the model, which capture relevant object-background distinctions. The binary segmentation mask (for single-object detection) or instance segmentation mask (for multi-object detection) 410 serves as the target output. During training, the model learns to generate an output from the input image that matches the target output as closely as possible. The difference between the predicted output (e.g., predicted binary/instance segmentation mask) and the target output 410 is computed using a loss function. For binary segmentation, the loss function may include binary cross-entropy (BCE). For instance segmentation, Soft Jaccard loss (a differentiable variant of intersection-over-union (IoU)) may be used, as it balances the loss per instance rather than per pixel. This loss is then backpropagated through the network to adjust the model's internal parameters (e.g., weights or biases). In some embodiments, data augmentation techniques (e.g., random cropping, rotation, and color jittering) may be applied to improve generalization and improve the model's reliability to variations in input images.

The workflow 400B demonstrates the process of training the matting model, which refines object boundaries and generates alpha channels and foreground color images for each object within the input data (e.g., images or frames of video files). To prepare the training data for the matting model, binary/instance segmentation masks 410 (generated by the annotation module 405, manually, semi-automated or fully-automated) and other ground truth data associated with the training image 320 are processed by an alpha and color extraction module 420 to generate the target outputs for the matting model. The target outputs include, as depicted, the alpha mattes 425 and foreground color images 430.

As used herein, the alpha matte 425 refers to a grayscale image, where each pixel represents the transparency value (opacity) of the corresponding pixel in the original image. The pixel values may range from 0 to 1 (or 0 to 255 in an 8-bit representation), where 0 represents fully transparent, 1 represents fully opaque, and intermediate gray values represent partial transparency (e.g., hair, smoke, glass, or soft shadows). If a person is standing in front of a background, the alpha matte 425 would show the person in white (fully opaque), the background in black (fully transparent), and soft edges in gray (partially transparent transitions).

As used herein, the foreground color image 430 refers to a RGB image but contains only the extracted foreground object without any background. Each pixel stores the true RGB values of the foreground object, which is unmixed from the background to ensure no color spill. When used in compositing, this image is blended with a new background using the determined RGB values and transparency information to generate new images. For example, if an extracted object is a person, the foreground image contains only the person's colors, with transparent regions (e.g., hair strands) preserving fractional RGB values that can be naturally blended using the alpha matte.

In embodiments where a training image contains multiple objects (e.g., Object A, Object B, and Object C), an alpha mask and a foreground color image may be generated (e.g., via the alpha and color processing module 420) for each individual object as the target output. With the target data, the matting model leans to predict the corresponding alpha channel and foreground color for each object within a compositing image during inference.

As depicted, since a binary segmentation mask 410-1 only distinguishes foreground (1) and background (0), it can be directly processed by the alpha and color processing module 420 to generate the alpha matte 425 and foreground color image 430. As discussed above, an instance segmentation mask 410-2 contains multiple labeled objects. As depicted, the instance segmentation mask 410-2 needs first be divided into separate binary masks 412 for each object before being processed by the alpha and color processing module 420. The separation process converts the instance segmentation mask into a binary label format, where the target object is labeled as 1 and the remaining part, including the background, is labeled as 0. This transformation ensures that the alpha channel 425 and foreground color 430 are generated independently for each object, allowing the matting model to process transparency and color information separately for each instance in the image.

With the alpha matte 425 and foreground color image 430 produced, in some embodiments, additional data may be generated to improve training, including trimaps with random dilation augmentation 435, and masks of semi-transparent regions 440. The additional data may provide more detailed guidance to the matting model, helping the model to learn fine-grained transparency effects and object boundaries more effectively.

As used herein, a trimap 435 is a grayscale image created by dilating or eroding the alpha channel with spatially varying radiuses. Within the trimap, three regions are defined: a foreground region (alpha=1), where pixels are fully opaque, a background region (alpha=0), where pixels are fully transparent, and an uncertain region (0<alpha<1), where transparency is ambiguous (e.g., hair, soft edges, reflections, or motion blur). In some embodiments, the trimaps serve as an intermediate representation that guides the matting model by indicating areas where refine transparency predictions should be refined.

As used herein, a mask of semi-transparent region(s) 440 is also a grayscale image, but with a focus on highlighting areas with partial transparency (where 0<alpha<1). The mask of semi-transparent region(s) 440 isolates regions such as soft edges, hair, fur, smoke, glass, shadows, and motion blur. Unlike trimaps, which define foreground, background, and uncertain regions, this mask of semi-transparent region(s) 440 exclusively emphasizes semi-transparent areas. In some embodiments, the mask of semi-transparent region(s) 440 may provide the model extra guidance on handling the complex semi-transparent regions.

The generated trimaps 435 and masks of semi-transparent regions 440 may be used to improve model training. Specifically, the mask of semi-transparent regions is used to determine which regions the loss function is computed on, providing the model with more precise feedback about object boundaries, soft edges, and transparency variations. As depicted in workflow 400B, the training images 320, along with the trimaps 435, may be used as input data for training the matting model 445. The alpha mattes 425 and foreground colors 430 serve as target outputs. In some embodiments, the matting model may use a UFormer structure, which includes three main components: an encoder, one or more transformer blocks, and a decoder. More details about the model's structure are provided below with reference to FIG. 6.

During training, the matting model learns to generate alpha mattes 425 and foreground colors 430 that match the target outputs (ground truth). The input training images 320, along with additional features like trimaps 435, are provided to the model. Based on the provided data, the matting model generates predicted alpha channels and foreground color images. Following that, the predicted outputs are compared with the target outputs (ground truth alpha channels 425 and foreground colors 430), and the difference is calculated using a loss function (e.g., L1/L2 loss, Fourier loss). The error (or loss) is then backpropagated through the network to update the internal parameters of the model. Through the iterative optimization, the model is refined to predict high-quality alpha channels and recover true foreground colors without contamination from the background.

In some embodiments, the matting model is also supervised to predict the background of the input image. This additional supervision is useful during training, as it constrains the model to produce outputs that, when recomposed, corresponds to the original input image.

In some embodiments, to ensure the model performs accurately and reliably before deployment, validation and testing datasets may be used during training to monitor the model's performance. More specifically, a validation dataset may be used to assess the model's (e.g., the segmentation model or matting model) performance on unseen data to prevent overfitting—where the model memorizes the training data but fails to generalize to new samples. Based on the evaluation, one or more hyperparameters of the model, such as leaning rate and dropout rate, may be adjusted to improve generalization. In some embodiments, techniques like early stopping may be applied, where training is halted once validation performance stops improving. After training and before deployment, a testing dataset may be used to evaluate the model's accuracy on completely unseen data. Unlike the validation dataset, which is used to fine-tune the model, the testing dataset serves as the final benchmark for real-world performance. Various metrics may be used for evaluation, and once the model achieves performance that meets a defined accuracy threshold on the testing dataset, it is considered ready for deployment. The trained segmentation and matting models may then be integrated into real-time systems, where it processes live input images (for still-image compositing applications) or video frames (for real-time VFX workflows).

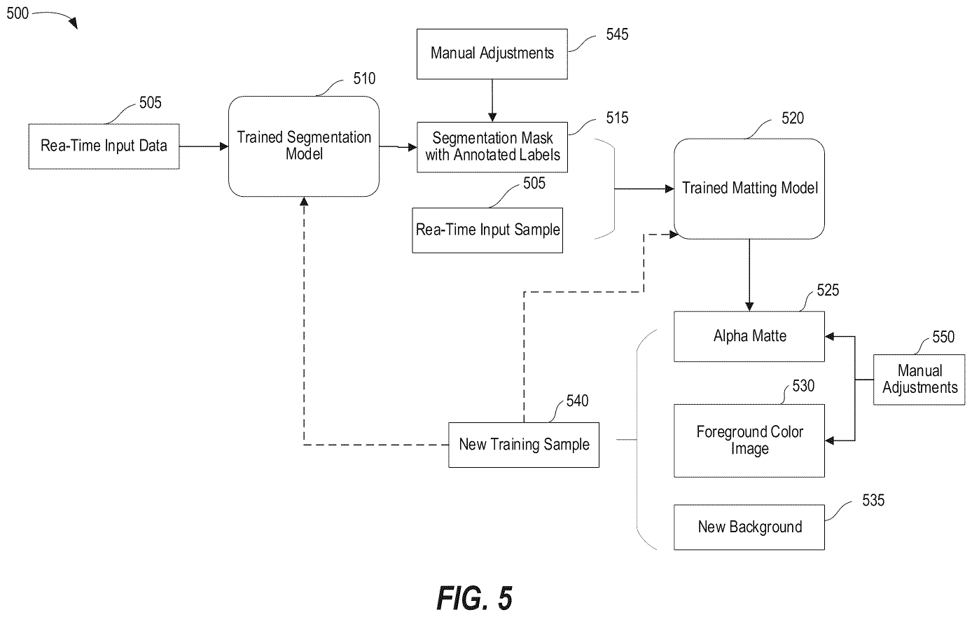

FIG. 5 depicts an example workflow 500 for performing bootstrapped rotoscope-matting for real-time input using trained segmentation and matting models, according to some embodiments of the present disclosure. The workflow 500 may be integrated within VFX applications to perform various tasks, such as foreground object extraction and background replacement.

As depicted, the real-time input data 505 is provided to the trained segmentation model 510 to generate a segmentation mask with annotated labels 515. The real-time input data 505 may include either a single image or an ordered sequence of frames from a video file. In embodiments where the input comprises a sequence of frames, each frame may be individually processed by the segmentation model 510 to generate a segmentation mask 515, followed by the matting model 520 to extract alpha mattes and foreground colors. The processed frames may then be reassembled in their original temporal order to maintain consistency across frames for video compositing.

The trained segmentation model 510 analyzes the input data 505 and produces the corresponding segmentation masks 515. In embodiments where the input image (or frame) contains only one foreground object, the segmentation model 510 may generate a binary segmentation mask, where pixels corresponding to the background are labeled as 0, and pixels corresponding to foreground object are labeled as 1. In embodiments where the input image (or frame) contains multiple foreground objects, the segmentation model may generate an instance segmentation mask, where pixels corresponding to the background are labeled as 0, and each foreground object is assigned a unique label (e.g., Object A=1, Object B=2, Object C=3). The unique labels allow to distinguish between multiple objects in the scene.

As depicted, following segmentation, the segmentation mask 515 and the input image 505 are provided to the matting model 520 for further processing. As discussed in FIG. 5, the matting model 520 is trained to process binary segmentation mask to generate alpha mattes and foreground color images. In embodiments where the input segmentation mask 515 is binary, the mask 515 may be directly processed by the matting model 520 to produce an alpha channel 525 (which defines the transparency levels of the object) and a foreground color image 530 (which contains the extracted foreground object without background contamination) for the foreground object. In embodiments where the input segmentation mask 515 is an instance mask, the matting model may process each object individually, treating it as a separate binary task. For example, if the segmentation mask contains three labeled objects (e.g., Object A=1, Object B=2, Object C=3), the matting model 520 may process the mask three times, once for each object. Through this approach, the segmentation mask is converted into a binary format, where only one object is labeled as 1 and everything else (other objects and background) is labeled as 0. The matting model 520 may then generate an alpha matte and a foreground color image for the target object (also referred to in some embodiments as the selected object). This process may be repeated for each labeled objects (e.g., Objects A, B, and C) to generate separate alpha and foreground color outputs. For example, if the input images includes three objects, a total of three alpha mattes are generated, one for each object, and a total of three foreground color images are generated, each corresponding to one of the three objects.

With the generated outputs, including alpha mattes 525 and foreground color images 530, one or more new images 540 may be generated by compositing the extracted objects onto a new background 535. The alpha matte defines transparency levels of the object, while the foreground color image provides the extracted object's color values (e.g., RGB values). With the known alpha and foreground color, the matting equation may be applied to blend the foreground object with a new background. The newly generated images 540 provide realistic transitions at object boundaries without color spill, particularly for soft edges and semi-transparent regions. The new background 535 may include various types, including but not limited to, uniform color backgrounds, photorealistic backgrounds, procedurally generated backgrounds (e.g., mosaic patterns), smoothly varying backgrounds, and dynamic or animated backgrounds. The new images 540 may be provided back into the training pipeline to further refine and improve the segmentation and matting models (as depicted by the dash lines). The iterative learning process improves the models by exposing them to training data samples with a broader range of compositions, lighting conditions, textures, and object-background interactions. As the segmentation and matting models are iteratively trained with these diverse, dynamically generated training samples, the models may develop a stronger ability to generalize across rapidly changing environments, improving both accuracy and reliability in handling complex scenes and real-time processing tasks.

In some embodiments, the disclosed inference workflow 500 may support manual adjustments 545 and 550, allowing inputs from users to further refine the model-generated outputs (e.g., segmentation masks, alpha mattes, and foreground color images). For example, when the segmentation mask 515 is generated by the segmentation model 510, users may modify object boundaries or update object labels to further refine segmentation accuracy. The adjusted mask may then be provided back into the training pipeline, improving the model's performance based on refined data. Similarly, modifications 550 may also be applied to the generated alpha mattes 525 and foreground color images before compositing. If transparency values or color details require refinement, adjustments may be introduced to facilitate smooth blending and accurate object integration. The refined alpha matte and foreground color image may then be used to improve the matting model's ability to handle fine details.

In embodiments where the real-time input image 505 is a high dynamic range (HDR) image, additional data processing and analysis may be used to handle the image's expanded luminance range and non-linear intensity distribution. HDR images are different from standard low-dynamic range (LDR) images by capturing a much wider range of brightness levels and preserving details in both extremely bright and dark regions. This characteristic makes HDR images valuable in photorealistic rendering and VFX, but it also introduces complications in model training and inference.

One challenge with HDR images is that brightness values can be significantly higher than standard 8-bit or 16-bit image representations, leading to a skewed intensity distribution where a few extremely bright pixels dominate the loss function. In some embodiments, a non-linear transformation may be used to normalize the intensity values closer to a normal distribution before training. However, directly applying a linear RGB conversion during training can lead to numerical instability in the backward pass, making it difficult for the model to learn accurate transparency and foreground color predictions. To address this, instead of modifying HDR processing during training, the disclosed workflow 500 applies a correction step during inference to recover HDR values without causing distortions in brightness. More specifically, the HDR input image is first clamped to the range of 0 to 1—scaling down pixel intensity values such that all values above 1 are set to 1 (white) and all values below 0 are set to 0 (black). The normalization step prevents overexposure issues in the network's processing pipeline while keeping the model within a normalized intensity range. The clamped image is then processed by the trained segmentation model 510 and matting model 520 and generates segmentation masks 515, alpha mattes 525, and foreground color images 530 based on the normalized intensity values. After processing, the input-to-output ratio is computed per pixel and per RGB channel to estimate how the HDR values were modified during model inference. Finally, these computed ratio values are used to multiply the model's output (e.g., foreground RGB values in [0, 1] range) and restore the fully dynamic range with preserved details in highlights and shadows.

FIG. 6 depicts the internal structures 600A and 600B of a segmentation or matting model, according to some embodiments of the present disclosure. The model (e.g., segmentation or matting model) follows an UFormer structure, which includes the following main components: an encoder that extracts hierarchical features from the input, a decoder that reconstructs the final output, one or more transformer blocks in the middle, which improve feature representation by capturing long-range dependencies, and residual/skip connections, which directly link layers in the encoder to corresponding layers in the decoder and facilitates feature reuse and improves gradient propagation during training. The disclosed structures 600A and 600B may be applied to both the segmentation model (e.g., 510 of FIG. 5) and the matting model (e.g., 520 of FIG. 5). 600A depicts the model structure when the input data is a single frame. 600B depicts the model structure when the input data includes multiple frames in a structured sequence. The structure 600B enables temporal-aware processing for video applications.

In 600A, the model processes a single image through a multi-stage pipeline that includes an encoder 615, one or more transformer blocks 625, and a decoder 630. In embodiments where the model is a segmentation model, the input 605 is a single image, such as a still image or a frame extracted from a video. In embodiments where the model is a matting model, the input data 605 includes the original image and the corresponding segmentation mask (which provides an initial object-background separation). The encoder 615 extracts low-level to high-level features from the input image using convolutional layers 620 and downsampling operations (e.g., pooling layers). The encoded features are passed through one or more transformer blocks 625 to improve feature representation. More specifically, the transformer blocks 625 use self-attention mechanism to capture long-range dependencies across different image regions. In the segmentation model, the captured long-range dependencies help to distinguish objects from backgrounds. In the matting model, the captured dependencies improve matting performance by preserving fine details in semi-transparent regions and edges. As depicted, the decoder 630 upsamples the processed features using convolutional layers 635 and upsampling operations, restoring the image to its original resolution while refining the object boundaries. The decoder 630 integrates both high-level features (from the transformer blocks) and low-level spatial details (from the encoder) to generate final outputs 685. If the model is a segmentation model, the output 685 is a segmentation mask, which can be either a binary segmentation mask (for single-object detection) or an instance segmentation mask (for multi-object detection). If the model is a matting model, the output 685 includes two parts: the alpha mattes and foreground color images.

600B extends the model structure from 600A to process a sequence of n frames and enables temporal-aware processing for video applications. Instead of handling a single frame or image, the model 600B processes multiple frames simultaneously to improve consistency across time. As depicted, the input consists of n consecutive frames 610-1, 610-2, and 610-n. The model receives these frames as a structured sequence, so the model can learn temporal relationships between frames. The encoder 640 includes multiple sub-encoding units 645, where each unit includes multiple convolutional layers designed to a specific corresponding frame 610 from the input sequence. Each sub-encoding unit 645 extracts spatial features independently from its respective frame 610 and captures object edges, textures, and structural details. The outputs from all sub-encoding units 645 are then aggregated, and relevant positional and time encoding are applied to the processed feature maps. As used herein, the positional encoding is used to preserve spatial relationships with each frame. As used herein, the timing encoding is used to provide a reference for frame sequencing, allowing the model to learn inter-frame dependencies and maintain temporal coherence. The encoded feature maps are then flattened into a structure representation for transformer-based processing.

As depicted, the flattened features are provided into one or more transformer blocks 660, which utilize self-attention mechanism to analyze both spatial and temporal dependencies across frames. The outputs from the transformer blocks 660 are then provided to the convolutional layers 665 in the decoder 680 to perform frame-by-frame reconstruction. In embodiments where the model is a segmentation model, the output 690 for each frame is a segmentation mask that distinguishes the object from the background. In embodiments where the model is a matting model, the output 690 for each frame may comprise an alpha matte (defining pixel-wise transparency levels) and a foreground color image (indicating the exact color of the extracted foreground object without background contamination). The architecture 600B enables the model to process multiple frames in parallel, allowing for accurate object segmentation and matting in real-time video applications, such as VFX compositing, video editing, and augmented reality.

In the disclosed structures 600A and 600B, the model is designed to predict all layers within the image—foreground, background, and alpha—jointly using a single model. Instead of treating these tasks independently, this approach enables parameters sharing across tasks and improves efficiency and consistency in segmentation and matting. Additionally, the disclosed structure adopts an Uformer architecture, which integrates UNet with transformer blocks in the middle. The Uformer architecture combines the advantages of local feature extraction from convolutional layers and global context modeling from self-attention mechanism in transformers and therefore outperforms conventional UNet and GridNet structures, especially in tasks requiring high-resolution detail preservation and long-range dependencies (e.g., object segmentation and matting). The transformer blocks improve the model's ability to handle semi-transparent objects, fine textures (e.g., hair, fur), and complex boundaries, which leads to more accurate segmentation mask generation and alpha channel refinement.

In some embodiments, to further improve the performance of the matting models, a Fourier loss function may be used. Unlike traditional L1/L2 loss functions, which primarily focus on pixel-wise differences, Fourier loss places greater emphasis on high-frequency details. Therefore, the matting model using Fourier loss function can better preserve textures, fine edges, and transparency transitions, and reduce the need for additional edge-aware loss function. This approach simplifies model optimization while improving detail accuracy in alpha mattes.

In embodiments where a large number of unannotated images are available, a pre-trained backbone using self-supervised learning techniques (e.g., masked autoencoders (MAE)) may be used to further improve model performance. MAE enables the model to learn rich feature representations by masking parts of an image and training the model to reconstruct the missing content. The MAE therefore improves the model's ability to extract relevant patterns without manual annotations. In segmentation models, a pre-trained backbone can provide better object recognition and boundary detection, while in matting models, the pre-trained backbone ensures fine-detail preservation for more accurate alpha matte refinement.

Another potential improvement involves faster and more efficient video processing by optimizing the format in which information is represented and computed during model training and inference. Given the high degree of redundancy in videos, traditional frame-by-frame processing can be computationally expensive and inefficient. Instead of using random masking, in some embodiments, structured masking strategies may be used to reduce unnecessary computations while maintaining accuracy. For example, masking probabilities may be biased based on entropy metrics, prioritizing the masking of tokens that contain less information. In some embodiments, locality-sensitive hashing (LSH) may be used to merge similar tokens, reducing redundancy while preserving highly-relevant details. In some embodiments, expert choice routing may be used, where sparse computations are enforced at the transformer block level, optimizing both attention and feedforward processes for improved efficiency. A practical training approach may involve first pretraining an image autoencoder for lightweight per-frame compression and reconstruction, and then applying the encoder to cache latent codes for both images and videos. A MAE in latent space may be trained on a combination of images and videos using global attention mechanisms. The pre-trained blocks can subsequently be combined with lightweight decoder layers, potentially adding residual connections or refining the masking strategy to further improve performance. While primarily designed for segmentation and matting, this method may be broadly applied to various vision tasks, including depth estimation, optical flow, and image/video generation.

Beyond architectural enhancements, adjustments to the training data pipeline can further improve the performance and generalization of both segmentation and matting models. A more diverse dataset enables the models to better handle complex real-world conditions and improves their ability to extract fine details in foreground objects, such as soft edges, semi-transparent objects, and compositing effects. In some embodiments, the training dataset may be entirely replaced by a mix of real and synthetic foregrounds. Real-world captured objects, extracted through color triangulation or other ground truth acquisition techniques, provide accurate color and transparency information, while procedurally generated synthetic objects offer scalability and precise ground truth data. By combining these sources, the model is exposed to a broader range of object textures, lighting conditions, and transparency levels, allowing the model to generalize better across diverse environments and scene compositions.

In some embodiments, such as when generating training datasets, background colors may be chosen to match or closely resemble the foreground objects. This color matching technique is designed to create more challenging training samples. By matching the background and foreground color properties, the model is exposed to scenarios where distinguishing between foreground and background requires a deeper understanding of transparency and soft edges. This approach improves the model's capability to generalize to complex real-world scenarios where foreground and background colors may overlap or blend.

In some embodiments, controlled noise may be added to the composited images used for training. The controlled noise may help the layers to blend more naturally, making the synthetic training date more representative of real-world scenarios. Without added noise, models trained on artificially clean data may struggle to generalize to real-world images, where noises and lighting inconsistencies are common. In some embodiments, such as when generating a trimap as the additional input for training the matting model, a spatially varying dilation and erosion approach may be used instead of a fixed-width dilation. By adapting the dilation radius based on local object complexity, the method ensures that uncertain regions in the trimap (e.g., hair, fur, smoke, and blurred edges) are more naturally represented, leading to more accurate and realistic transparency predictions.

In some embodiments, to further improve computational efficiency, a recycling buffer may be integrated to reduce input/output (I/O) bottlenecks and improve loading and processing speeds during training and inference. Processing high-resolution images and videos requires substantial storage and memory resources, leading to potential bottlenecks in data transfer between storage and GPUs. With the integrated buffer, the training pipeline can efficiently handle large-scale datasets to ensure smooth real-time data access and prevent slowdowns caused by file I/O operations. Such optimization is beneficial for high-resolution image processing and large-scale dataset training.

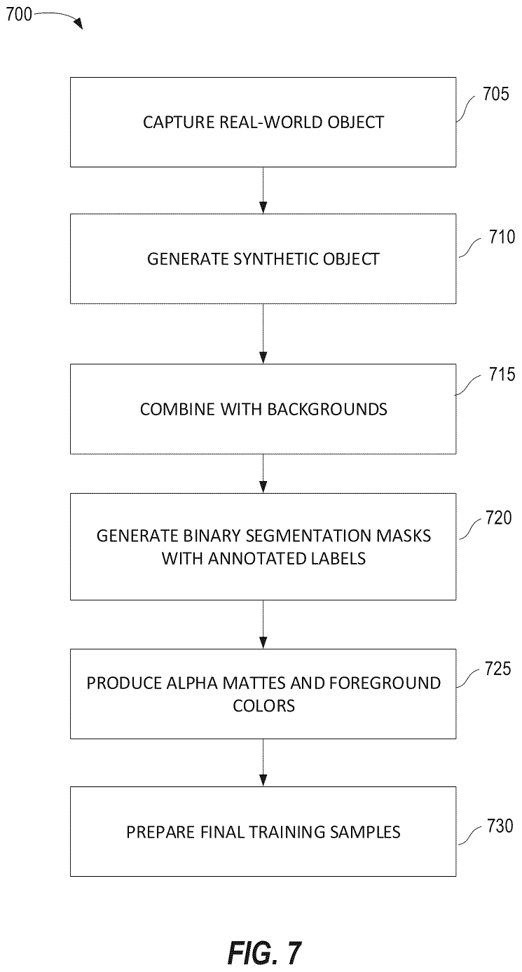

FIG. 7 depicts an example method 700 for preparing training data samples for segmentation and matting models, according to some embodiments of the present disclosure.

At block 705, real-world objects (e.g., 105 of FIG. 1) are captured using the color triangulation method to obtain accurate foreground colors and alpha values. The method may include capturing the object against multiple backgrounds (e.g., checkerboard pattern, black, white, and smoothly varying background), capturing background-only images without the object, and using the matting equation to determine the alpha values and foreground colors for each captured object.

At block 710, synthetic objects (e.g., 205 of FIG. 2) are procedurally generated and rendered to increase the diversity and scale of training data. The synthetic objects are generated with known ground truth segmentation masks and alpha values, providing clean training labels without manual intervention. Example of synthetic objects include, but are not limited to, 3D models of humans, animals, and plants.

At block 715, the generated real-world objects and synthetic objects are composited onto various backgrounds to generate various training samples. In one embodiment, a single real-world object or synthetic object may be composited onto different background images to generate a variety of training samples (as depicted by 300A of FIG. 3). The backgrounds may include solid colors, procedurally generated textures, photorealistic images, dynamic images, and the like. In an alternative embodiment, multiple real-world and synthetic objects may be combined into a single scene to simulate real-world occlusion and interaction between objects. Within the combined images, objects may overlap with varying degrees of transparency to challenge the segmentation and matting models in distinguishing object boundaries. This process creates diverse and complex training samples, and when used, models may generalize across various object placements and lighting conditions.

In embodiments where only real-world objects are used for training data, the operation at block 710 (synthetic object generation) can be skipped. If only synthetic objects are used, the operation at block 705 (real-world object capture) may be skipped. When both real-world and synthetic objects are incorporated into training data generation, the operations at blocks 705 and 710 may be performed either in parallel or sequentially, with the operation at block 705 proceeding the operation at block 710, or vice versa.

To train the segmentation model, segmentation masks (e.g., 410 of FIG. 4) are needed for each training sample. These marks define which regions belong to foreground objects and which belong to the background. At block 720, the segmentation masks are generated for training samples. The masks may be binary or instance segmentation masks. Binary segmentation masks label all foreground pixels as 1 and all background pixels as 0, while instance segmentation masks assign a unique label to each object in a multi-object scene (e.g., Object A=1, Object B=2) and mark background pixels as 0. The labels in the masks may be created through different annotation methods. In some embodiments, experts may annotate the segmentation masks manually by drawing contours or adjusting control points to precisely define object boundaries. In some embodiments, tools such as the SAM may assist in refining masks to reduce the need for manual annotation. For synthetic object, in some embodiments, render IDs may be used to generate the segmentation masks automatically without manual intervention.

Once segmentation masks are created, at block 725, training samples are processed to generate matting model training outputs, including alpha mattes (e.g., 425 of FIG. 4) and foreground color images (e.g., 430 of FIG. 4). The alpha matte represents pixel-level transparency values in grayscale, where fully transparent areas are marked as 0, fully opaque areas are marked as 1, and partially transparent areas (e.g., soft edges, hair, some, or glass) are assigned intermediate gray values. The foreground color image contains the true and unmixed foreground colors (e.g., RGB values) extracted from the composite image. In some embodiments, trimaps and masks of semi-transparent regions may also be generated by processing the training images along with their corresponding segmentation masks. These additional data sources (trimaps and semi-transparent masks) may be used as extra inputs during matting model training, providing the model with more detailed transparency information for improved accuracy in real-world application.

At block 730, the training samples are paired with their respective target outputs to be provided into the segmentation and matting models for training. For segmentation model, the input may include training images with composite backgrounds, and the target output may include binary or instance segmentation masks. For matting model, the input may include training images, segmentation masks, and optionally generated trimaps and masks of semi-transparent regions, and the target output may include alpha mattes and foreground color images.

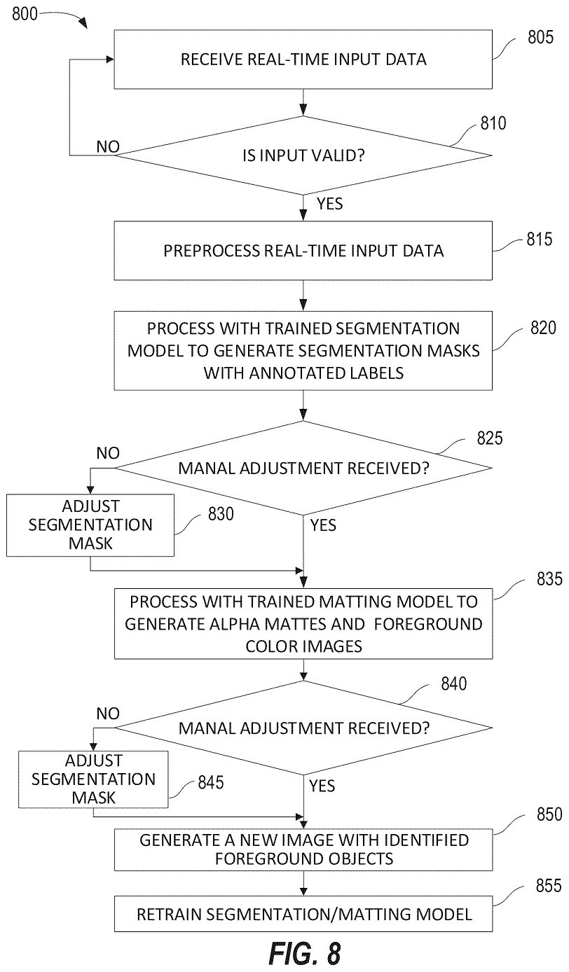

FIG. 8 depicts an example method 800 for performing real-time inference using segmentation and matting models, according to some embodiments of the present disclosure. The example method 800 may be performed by any computing device or system, such as physical computer or server, cloud-based system, or specialized hardware, as long as the device is configured with the necessary software and computational resources to execute the described example method 800.

At block 805, a computing system receives real-time input data (e.g., 505 of FIG. 5), which may include a single image or a sequence of frames from a video file. When the input is a sequence of frames, each frame is processed individually by the segmentation and matting models, which can be achieved through separate sub-encoding units, each comprising convolutional layers (e.g., 645 of FIG. 6) and pooling layers. To preserve temporal coherence, the models are trained to preserve the original frame order and may incorporate position and time encoding mechanisms within the transformer layers.

At block 810, the computing system evaluates whether the received input data is valid for processing. The validity check may include, but are not limited to, verifying whether the file format is supported, checking if the image or video frame contains sufficient resolution and quality for processing, and detecting whether the input is corrupt or missing required metadata. If the input is valid, the method 800 proceeds to block 815. If the input is invalid, the method 800 returns to block 805, where the computing system requests a new input, or in some embodiments, initiate the process to recover missing data before proceeding.

At block 815, after the input is validated, the computing system performs preprocessing on the received data. The preprocessing is conducted to ensure optimal (or at least improved) segmentation and matting performance. The preprocessing steps may vary depending on whether the received input includes regular images (or video frames) or HDR images (or HDR video frames). In embodiments where the received input includes regular images or video frames (including images that have a standard dynamic range and color space), the preprocessing may include applying noise reduction or sharpening to improve input quality and improve feature extraction by the segmentation model. If the image contains underexposed or overexposed regions, the system may adjust the image's brightness and contrast to improve its quality. In embodiments where the received input includes HDR images or HDR video frames (including images with a high dynamic range that contain brightness values exceeding the standard [0,1] range), the preprocessing may include clamping intensity values to the [0, 1] range to prevent extreme brightness from overwhelming the segmentation and matting models. In some embodiments, an input-output ratio correction mechanism may be used to ensure that HDR values can be recovered post-processing so that highlights and shadow details can be preserved after matting.

At block 820, the preprocessed image or frame is passed through the trained segmentation model (e.g., 510 of FIG. 5), which generates a segmentation mask (e.g., 515 of FIG. 5) that identifies foreground objects. The segmentation mask may be a binary mask (which labels foreground objects as 1 and background as 0) (e.g., 410-1 of FIG. 4) or an instance segmentation mask (which assigns a unique label to each object in multi-object scenes) (e.g., 410-2 of FIG. 4).

After the segmentation mask is generated, in some embodiments, the mask may be provided to an expert for manual review, particularly when the segmentation model encounters complex boundaries, overlapping objects, or semi-transparent objects.

During this stage, the expert may refine object boundaries to correct misclassified pixels or incorrect edges and manually separate overlapping objects if the instance segmentation mask incorrectly merges multiple objects into a single label. At block 825, the computing system checks whether user input (e.g., 545 of FIG. 5) has been received to adjust the mask. If no manual input is detected, the method 800 proceeds to block 835, where the segmentation mask is used as input for the matting model. If manual adjustments are received, the method 800 moves to block 830, where the mask is updated based on received user input and replaces the original mask. The method 800 then proceeds to block 835, where the refined segmentation is used in the subsequent matting process.

At block 835, the segmentation mask and input image are passed through the trained matting model (e.g., 520 of FIG. 5), which produces alpha mattes (e.g., 525 of FIG. 5) and foreground color images (e.g., 530 of FIG. 5). If the input segmentation mask is binary (e.g., the image contains a single foreground object), the matting model directly generates one alpha matte and one foreground color image corresponding to the segmented object. If the input segmentation mask is an instance segmentation mask (e.g., the image contains multiple labeled foreground objects), the matting model processes each labeled object separately, generating multiple alpha mattes and foreground color images, one of each object. In some embodiments, the generated alpha mattes and foreground color images may then undergo manual review to determine whether any refinements are required to improve edge quality or color accuracy.

At block 840, the system checks whether user input is received to adjusts the generated alpha mattes and foreground color images. If no manual input is received, the system proceeds to block 850, where the foreground objects are composited onto new backgrounds. If manual adjustments are made, the method 800 moves to block 845, where refinements are applied to fine-tune transparency values and correct edge artifacts. The updated alpha mattes and foreground color images then replace the originals before proceeding to block 850.

At block 845, using the alpha mattes and foreground color images, the system composites the extracted foreground objects onto a new background to generate a new image or video frame (e.g., 540 of FIG. 5). The matting equation is applied to blend the foreground object with the new background to ensure smooth transition and realistic integration.

At block 850, the newly generated images may be provided back into the training pipeline to further improve the segmentation and matting models. The new images expand the training datasets, helping the models adapt to diverse object-background combinations. Through iterative training, the models become increasingly robust and reliable over time and are capable of handling more complex scenes with higher accuracy.

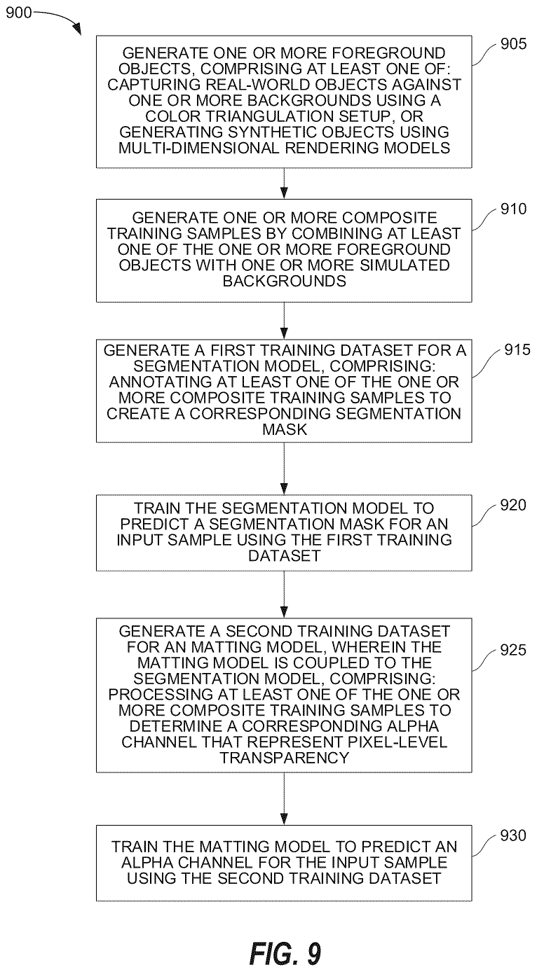

FIG. 9 is a flow diagram depicting an example method 900 for segmentation and matting model training, according to some embodiments of the present disclosure.

At block 905, a computing system generates one or more foreground objects, comprising at least one of capturing real-world objects (e.g., 305 of FIG. 3) against one or more backgrounds using a color triangulation setup, or generating synthetic objects (e.g., 310 of FIG. 3) using multi-dimensional rendering models.

At block 910, the computing system generates one or more composite training samples (e.g., 320 of FIG. 3) by combining at least one of the one or more foreground objects with one or more simulated backgrounds (e.g., 315 of FIG. 3).

At block 915, the computing system generates a first training dataset for a segmentation model, comprising annotating at least one of the one or more composite training samples to create a corresponding segmentation mask (e.g., 410 of FIG. 4).

At block 920, the computing system trains the segmentation model (e.g., 510 of FIG. 5) to predict a segmentation mask (e.g., 515 of FIG. 5) for an input sample using the first training dataset.

In some embodiments, the computing system may further generate a second training dataset for a matting model, where the matting model is coupled to the segmentation model, comprising at least one of processing at least one of the one or more composite training samples to produce a corresponding alpha matte (e.g., 425 of FIG. 4) that represents pixel-level transparency, or processing at least one of the one or more composite training samples to produce a corresponding foreground color image (e.g., 430 of FIG. 4). The computing system may then train the matting model (e.g., 520 of FIG. 5) to predict at least one of an alpha matte (e.g., 525 of FIG. 5) or a foreground color image (e.g., 530 of FIG. 5) for the input sample using the second training dataset.

In some embodiments, the one or more simulated backgrounds (e.g., 315 of FIG. 3) combined with a foreground object may be varied in at least one of lighting, texture, or color.

In some embodiments, the segmentation mask may comprise a binary mask, with a first value representing a foreground object within a training sample, and a second value representing a background region within the training sample.

In some embodiments, the process of annotating the least one of the one or more composite training samples to create the corresponding segmentation mask may comprise at least one of manually annotating the least one of the one or more composite training samples to identify foreground objects, annotating the least one of the one or more composite training samples using a segmentation tool configured to assist in generating the corresponding segmentation mask, or automatically annotating the least one of the one or more composite training samples using render identities (IDs) associated with synthetic objects.

In some embodiments, the computing system may process the input sample using the trained segmentation model, comprising extracting one or more input features from the input sample, analyzing the one or more input features to capture object-level relationships, and generating the segmentation mask for the input sample, where a first value represents a foreground object, and a second value represents a background region in the input sample. The computing system may then process the segmentation mask and the input sample using the trained matting model, comprising extracting one or more input features from the input sample and the segmentation mask, analyzing the one or more input features to capture pixel-level dependencies, and generating at least one of the alpha matte or the foreground color image for the input sample.

In some embodiments, the input sample may comprise at least one of an input image or an input frame from a video.

In some embodiments, the computing system may generate a new composite sample by combining the foreground objects of the input sample with a new background; and blending the foreground objects with the new background based on the alpha matte and the foreground color image for the input sample.

In some embodiments, the computing system may retrain the segmentation model using the new composite sample, and retrain the matting model using the new composite sample.

In some embodiments, the segmentation model may comprise an encoder-transformer-decoder framework, comprising an encoder (e.g., 615 or 640 of FIG. 6) to extract multi-scale features from the input sample, the encoder comprising one or more convolutional layers and a pre-trained backbone network, one or more transformer blocks (e.g., 625 or 660 of FIG. 6) to capture long-range dependencies between objects within the input sample, and an decoder (e.g., 630 or 680 of FIG. 6) to predict the segmentation mask for the input sample.

In some embodiments, the matting model may comprise an encoder-transformer-decoder framework, comprising an encoder (e.g., 615 or 640 of FIG. 6) to extract multi-scale features from the input sample and guidance inputs, where the guidance inputs comprise at least one of the segmentation mask (e.g., 410 of FIG. 4) generated by the segmentation model for the input sample or a trimap of the input sample (e.g., 435 of FIG. 4), one or more transformer blocks (e.g., 625 or 660 of FIG. 6) to capture long-range dependencies within the input sample for pixel-level precision, and an decoder (e.g., 630 or 680 of FIG. 6) to generate outputs for the input sample, the outputs comprising at least one of an alpha matte or a foreground color image for the input sample.

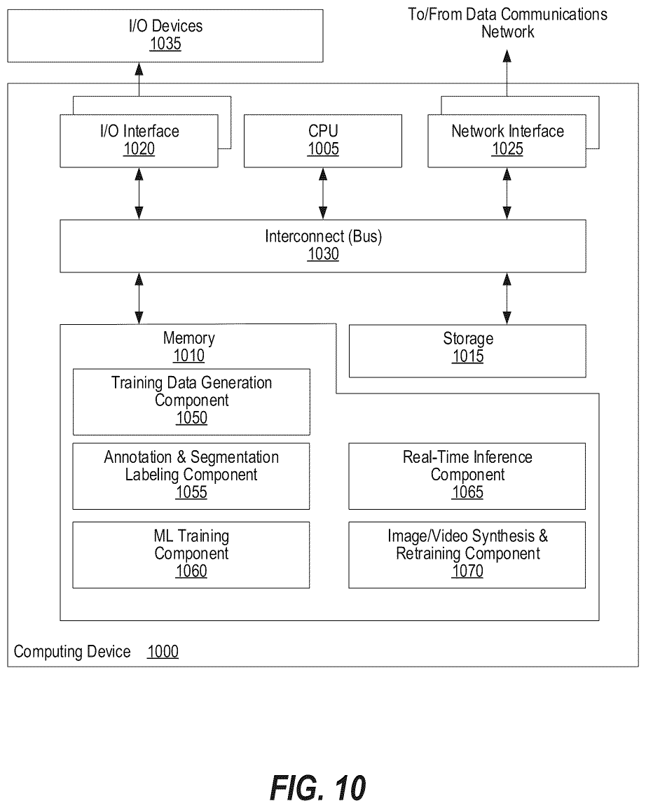

FIG. 10 depicts an example computing device 1000 configured to perform various aspects of the present disclosure, according to some embodiments of the present disclosure.

As illustrated, the computing device 1000 includes a CPU 1005, memory 1010, storage 1015, one or more network interfaces 1025, and one or more I/O interfaces 1020. In the illustrated aspect, the CPU 1005 retrieves and executes programming instructions stored in memory 1010, as well as stores and retrieves application data residing in storage 1015. The CPU 1005 is generally representative of a single CPU and/or GPU, multiple CPUs and/or GPUs, a single CPU and/or GPU having multiple processing cores, and the like. The memory 1010 is generally considered to be representative of a random access memory. Storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 1035 (e.g., keyboards, monitors, camera 145 with built-in processor 150, as depicted in FIG. 1) are connected via the I/O interface(s) 1020. Further, via the network interface 1025, the computing device 1000 can be communicatively coupled with one or more other devices and components (e.g., via a network, which may include the Internet, local network(s), and the like). As illustrated, the CPU 1005, memory 1010, storage 1015, network interface(s) 1025, and I/O interface(s) 1020 are communicatively coupled by one or more buses 1030.

In the illustrated aspect, the memory 1010 includes a training data generation component 1050, an annotation and segmentation labeling component 1055, a machine learning (ML) training component 1060, a real-time inference component 1065, and an image/video synthesis and retraining component 1070.

In one embodiment, the training data generation component 1050 may be configured to prepare input images and video frames before they are used for model training or inference. For real-world objects, the training data generation component 1050 may apply the color triangulation method to extract foreground elements and alpha mattes with minimized (or at least reduced) color spill. For synthetic objects, the training data generation component 1050 may use procedural rendering techniques to generate synthetic objects with precise ground truth alpha mattes. Additionally, the training data generation component 1050 may perform compositing, where extracted foreground objects are placed onto various background types (e.g., photorealistic, procedurally generated, dynamic backgrounds) to simulate diverse real-world scenarios. The generated composite images may then be used for model training.

In one embodiment, the annotation and segmentation labeling component 1055 may be configured to generate segmentation masks for training data, allowing segmentation models to differentiate foreground objects from the background. The annotation and segmentation labeling component 1055 may support three annotation methods: manual annotation (where experts refine segmentation masks by drawing contours or adjusting control points), semi-automated annotation (where SAM or other tools are used in refining segmentation masks iteratively), and fully automated annotation (where render IDs for synthetic objects are used directly to generate segmentation masks without human intervention).

In one embodiment, the ML training component 1060 may handle the training of segmentation and matting models using the generated training datasets. The ML training component 1060 may facilitate the training of segmentation models to classify pixels into binary segmentation mask or instance segmentation masks (assigning unique labels to multiple objects). The matting model may be trained to refine object edges, generate high-resolution alpha mattes, and extract true foreground colors. The training process may incorporate loss function like L1/L2 loss or Fourier loss to improve accuracy. In some embodiments, pretrained backbones (e.g., Masked Autoencoders (MAE)) may be used to improve model performance on large-scale unannotated datasets.

In one embodiment, the real-time inference component 1065 may apply the trained segmentation and matting models to real-time input data (e.g., images or video frames). The segmentation model generates binary or instance segmentation masks, and the matting model produces alpha mattes and foreground color images. In some embodiments, the real-time inference component 1065 may include an HDR processing pipeline, which clamps HDR images to the [0,1] range before inference and applies input-output ratio correction post-processing to preserve highlight details. Additionally, in some embodiments, a manual refinement interface may be incorporated, allowing user to review and adjust model outputs (e.g., segmentation masks, alpha mattes, foreground color outputs) to improve final composition quality.

In one embodiment, the image/video synthesis and retraining component 1070 may generate final composited images or video frames by blending foreground objects with new backgrounds using the matting equation. The newly generated images may be provided back into the training pipeline, allowing the segmentation and matting models to improve their performance through iterative retraining.

Although depicted as discrete components for conceptual clarity, in some aspects, the operations of the depicted components (and others not illustrated) may be combined or distributed across any number of components. Further, although depicted as software residing in memory 1010, in some aspects, the operations of the depicted components (and others not illustrated) may be implemented using hardware, software, or a combination of hardware and software.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
generating one or more foreground objects, comprising at least one of:
capturing real-world objects against one or more backgrounds using a color triangulation setup, or
generating synthetic objects using multi-dimensional rendering models;
generating one or more composite training samples by combining at least one of the one or more foreground objects with one or more simulated backgrounds;
generating a first training dataset for a segmentation model, comprising:
annotating at least one of the one or more composite training samples to create a corresponding segmentation mask; and
training the segmentation model to predict a segmentation mask for an input sample using the first training dataset.

2. The method of claim 1, further comprising:
generating a second training dataset for a matting model, wherein the matting model is coupled to the segmentation model, comprising at least one of:
processing at least one of the one or more composite training samples to produce a corresponding alpha matte that represents pixel-level transparency; or
processing at least one of the one or more composite training samples to produce a corresponding foreground color image; and
training the matting model to predict at least one of an alpha matte or a foreground color image for the input sample using the second training dataset.

3. The method of claim 1, wherein the one or more simulated backgrounds combined with a foreground object are varied in at least one of lighting, texture, or color.

4. The method of claim 1, wherein the segmentation mask comprises a binary mask, with a first value representing a foreground object within a training sample, and a second value representing a background region within the training sample.

5. The method of claim 1, wherein annotating the least one of the one or more composite training samples to create the corresponding segmentation mask comprises at least one of:
manually annotating the least one of the one or more composite training samples to identify foreground objects,
annotating the least one of the one or more composite training samples using a segmentation tool configured to assist in generating the corresponding segmentation mask, or
automatically annotating the least one of the one or more composite training samples using render identities (IDs) associated with synthetic objects.

6. The method of claim 2, further comprising:
processing the input sample using the trained segmentation model, comprising:
extracting one or more input features from the input sample,
analyzing the one or more input features to capture object-level relationships, and
generating the segmentation mask for the input sample, wherein a first value represents a foreground object, and a second value represents a background region in the input sample; and
processing the segmentation mask and the input sample using the trained matting model, comprising:
extracting one or more input features from the input sample and the segmentation mask,
analyzing the one or more input features to capture pixel-level dependencies, and
generating at least one of the alpha matte or the foreground color image for the input sample.

7. The method of claim 1, wherein the input sample comprises at least one of an input image or an input frame from a video.

8. The method of claim 6, further comprising generating a new composite sample by:
combining the foreground objects of the input sample with a new background; and
blending the foreground objects with the new background based on the alpha matte and the foreground color image for the input sample.

9. The method of claim 8, further comprising:
retraining the segmentation model using the new composite sample; and
retraining the matting model using the new composite sample.

10. The method of claim 1, wherein the segmentation model comprises an encoder-transformer-decoder framework, comprising:
an encoder to extract multi-scale features from the input sample, the encoder comprising one or more convolutional layers and a pre-trained backbone network;
one or more transformer blocks to capture long-range dependencies between objects within the input sample; and
an decoder to predict the segmentation mask for the input sample.

11. The method of claim 2, wherein the matting model comprises an encoder-transformer-decoder framework, comprising:
an encoder to extract multi-scale features from the input sample and guidance inputs, wherein the guidance inputs comprise at least one of the segmentation mask generated by the segmentation model for the input sample or a trimap of the input sample;
one or more transformer blocks to capture long-range dependencies within the input sample for pixel-level precision; and
an decoder to generate outputs for the input sample, the outputs comprising at least one of an alpha matte or a foreground color image for the input sample.

12. A non-transitory computer-readable medium containing computer program code that, when executed by operation of one or more computer processors, performs an operation comprising:
generating one or more foreground objects, comprising at least one of:
capturing real-world objects against one or more backgrounds using a color triangulation setup, or
generating synthetic objects using multi-dimensional rendering models;
generating one or more composite training samples by combining at least one of the one or more foreground objects with one or more simulated backgrounds;
generating a first training dataset for a segmentation model, comprising:
annotating at least one of the one or more composite training samples to create a corresponding segmentation mask; and
training the segmentation model to predict a segmentation mask for an input sample using the first training dataset.

13. The non-transitory computer-readable medium of claim 12, wherein the operation further comprises:
generating a second training dataset for a matting model, wherein the matting model is coupled to the segmentation model, comprising at least one of:
processing at least one of the one or more composite training samples to produce a corresponding alpha matte that represents pixel-level transparency; or
processing at least one of the one or more composite training samples to produce a corresponding foreground color image; and
training the matting model to predict at least one of an alpha matte or a foreground color image for the input sample using the second training dataset.

14. The non-transitory computer-readable medium of claim 12, wherein the one or more simulated backgrounds combined with a foreground object are varied in at least one of lighting, texture, or color.

15. The non-transitory computer-readable medium of claim 12, wherein the segmentation mask comprises a binary mask, with a first value representing a foreground object within a training sample, and a second value representing a background region within the training sample.

16. The non-transitory computer-readable medium of claim 13, wherein the operation further comprises:
processing the input sample using the trained segmentation model, comprising:
extracting one or more input features from the input sample,
analyzing the one or more input features to capture object-level relationships, and
generating the segmentation mask for the input sample, wherein a first value represents a foreground object, and a second value represents a background region in the input sample; and
processing the segmentation mask and the input sample using the trained matting model, comprising:
extracting one or more input features from the input sample and the segmentation mask,
analyzing the one or more input features to capture pixel-level dependencies, and
generating at least one of the alpha matte or the foreground color image for the input sample.

17. The non-transitory computer-readable medium of claim 12, wherein the input sample comprises at least one of an input image or an input frame from a video.

18. The non-transitory computer-readable medium of claim 16, wherein the operation further comprises generating a new composite sample by:
combining the foreground objects of the input sample with a new background; and
blending the foreground objects with the new background based on the alpha matte and the foreground color image for the input sample.

19. The non-transitory computer-readable medium of claim 12, wherein the segmentation model comprises an encoder-transformer-decoder framework, comprising:
an encoder to extract multi-scale features from the input sample, the encoder comprising one or more convolutional layers and a pre-trained backbone network;
one or more transformer blocks to capture long-range dependencies between objects within the input sample; and
an decoder to predict the segmentation mask for the input sample.

20. A system, comprising:
one or more memories collectively containing one or more programs; and
one or more processors, wherein the one or more processors are configured to, individually or collectively, perform an operation comprising:
generating one or more foreground objects, comprising at least one of:
capturing real-world objects against one or more backgrounds using a color triangulation setup, or
generating synthetic objects using multi-dimensional rendering models;
generating one or more composite training samples by combining at least one of the one or more foreground objects with one or more simulated backgrounds;
generating a first training dataset for a segmentation model, comprising:
annotating at least one of the one or more composite training samples to create a corresponding segmentation mask; and
training the segmentation model to predict a segmentation mask for an input sample using the first training dataset.
